(19) United States
(12) Patent Application Publication
(10) Pub. No.: US 2019/0041358 A1
(43) Pub. Date: Feb. 7, 2019

(54) Analysis Chip

(71) Applicant: ARKRAY, Inc., Kyoto (JP)

(72) Inventor: Naotsugu Onuma, Kyoto-shi (JP)

(73) Assignee: ARKRAY, Inc., Kyoto (JP)

(21) Appl. No.: 16/049,035

(22) Filed: Jul. 30, 2018

(30) Foreign Application Priority Data
Aug. 3, 2017 (JP) 2017-150736

(51) Int. Cl. G01N 27/447

(52) U.S. Cl. CPC G01N 27/44791; G01N 27/44743

(57) ABSTRACT

The disclosure provides an analysis chip that includes a microchip employing capillary electrophoresis and a cartridge.

### CROSS-REFERENCE TO RELATED APPLICATION

This application claims priority under 35 USC 119 from Japanese Patent Application No. 2017-150736, filed on Aug. 3, 2017, the disclosure of which is incorporated by reference herein.

### TECHNICAL FIELD

The present invention relates to an analysis chip that includes a microchip employed for capillary electrophoresis.

### RELATED ART

Conventionally, specimen analysis techniques have been performed by capillary electrophoresis. In recent years, microchip electrophoresis, which employs capillaries adapted for chip devices, has been performed, in order to miniaturize and to simplify such devices. In microchip electrophoresis, capillaries used for electrophoresis and reservoir wells for various types of solutions are formed on a single chip.

An example of such a microchip is described in JP 1999-337521 A. In this microchip, capillaries are formed in a cross shape. Another microchip is described in WO 2008/136465 A1, which is configured by only a single capillary and solution reservoir wells at both ends of the capillary. Further, a microchip provided with film-shaped electrodes is described in JP 4178653 B.

Furthermore, JP 2016-212090 A discloses a chip unit (an analysis instrument) configured by a microchip (a first unit) and a cartridge (a second unit). According to the disclosure, the chip unit is completed by coupling the microchip and the cartridge together, whereby a specific liquid contained in the cartridge is moved to the chip.

### SUMMARY

In the aforementioned JP 2016-212090 A, while the microchip and the cartridge are coupled together along a vertical height direction with respect to a flow path, there is no particular mention of the method of fixing the cartridge and the chip together. Some sort of fixing method is needed with this chip unit since external force will be applied to the chip unit when the chip unit is introduced into a measurement device, when the position of the chip unit in the measurement device is aligned after being introduced, or when an electrode for capillary electrophoresis is connected to the chip unit.

An exemplary embodiment of the present invention provides an analysis chip that includes a microchip employed for capillary electrophoresis and a cartridge. The analysis chip is structured so as to enable the microchip and the cartridge to be reliably coupled together and such that the microchip is able to be reliably housed in the cartridge.

An analysis chip provided as an exemplary embodiment of the present invention is employed to analyze a sample, and comprises a first unit that comprises a sample introduction portion into which the sample is introduced, and a second unit that is configured to house the first unit. The second unit comprises an insertion port into which the first unit is inserted. The first unit is formed so as to be moveable from a first state in which the sample introduction portion is positioned outside the second unit relative to the insertion port, to a second state in which the sample introduction portion is positioned inside the second unit relative to the insertion port. The second unit comprises a guide portion that guides the first unit from the first state to the second state.

In a preferred embodiment of the present invention, the first unit has two side edges running parallel to a direction of movement from the first state to the second state, and the guide portion is provided at a position along which both the side edges are slidable in the direction of movement.

In another preferred embodiment of the present invention, the second unit comprises a position restriction portion that holds the first unit in the second state.

Due to the embodiments of the present invention, an analysis chip can be provided that includes a microchip employed for capillary electrophoresis and a cartridge. The analysis chip has a structure in which the microchip and the cartridge can be reliably coupled together, and the microchip can be reliably housed in the cartridge. For example, an analysis chip 10 employed to analyze a sample 50 comprises a first unit 20 that comprises a sample introduction portion 21 into which the sample 50 is introduced, and a second unit 30 that is configured to house the first unit 20. The second unit 30 comprises an insertion port 31 into which the first unit 20 is inserted. The first unit 20 is formed so as to be moveable from a first state in which the sample introduction portion 21 is positioned outside the second unit 30 relative to the insertion port 31, to a second state in which the sample introduction portion 21 is positioned inside the second unit 30 relative to the insertion port 31. The second unit 30 comprises a guide portion 32 that guides the first unit from 20 the first state to the second state.

### BRIEF DESCRIPTION OF THE DRAWINGS

Exemplary embodiments will be described in detail based on the following figures, wherein:

FIG. 1A is a perspective view illustrating an analysis chip according to an exemplary embodiment of the present invention in a first state, and FIG. 1B illustrates the analysis chip in a second state.

FIG. 2 is a bottom view illustrating an analysis chip according to an exemplary embodiment of the present invention.

FIG. 3A is a cross-section taken along IIIA-IIIA in FIG. 1A, and FIG. 3B is a cross-section taken along IIIB-IIIB in FIG. 1B.

### DETAILED DESCRIPTION

Explanation follows regarding a preferred embodiment of the present invention, with reference to the drawings. Note that the following description and the drawings merely an example of the present invention, and the present invention is not limited thereto.

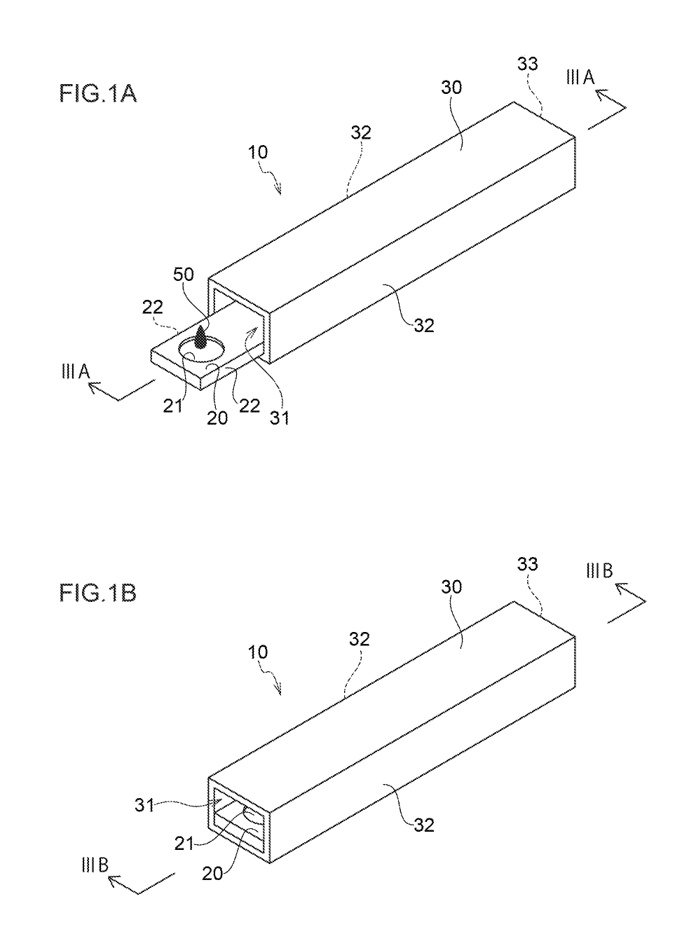

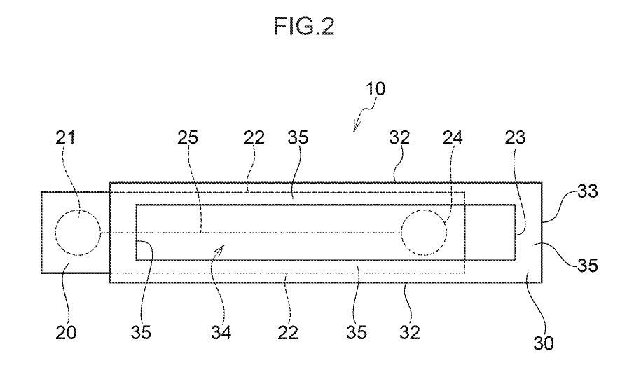

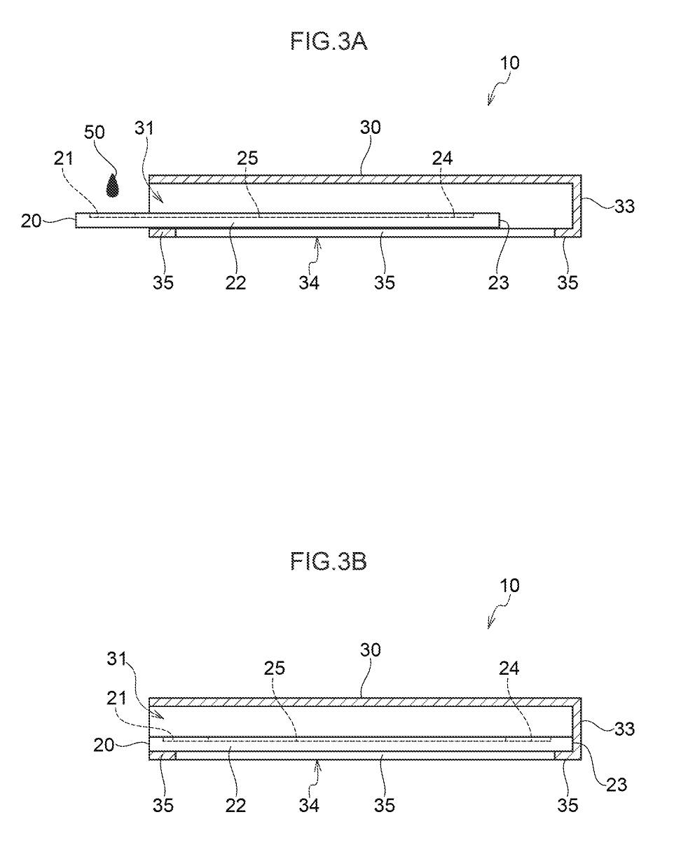

FIG. 1A and FIG. 1B, FIG. 2, and FIG. 3A and FIG. 3B illustrate an analysis chip 10 according to an exemplary embodiment of the present invention. The analysis chip 10 of the present exemplary embodiment comprises a microchip as a first unit 20 and a cartridge as a second unit 30.

FIG. 1A is a perspective view illustrating the analysis chip 10 in a first state in which the first unit 20 projects out from the second unit 30. FIG. 1B is a perspective view illustrating the analysis chip 10 in a second state in which the first unit 20 is contained within the second unit 30. FIG. 2 is a bottom view of the analysis chip 10. FIG. 3A illustrates the analysis chip 10 in the first state in which the first unit 20 projects out from the second unit 30, as seen in a cross-section taken along IIIA-IIIA in FIG. 1A. FIG. 3B illustrates the analysis chip 10 in the second state in which the first unit 20 is contained within the second unit 30, as seen in a cross-section taken along IIIB-IIIB in FIG. 1B.

The first unit 20 is formed as a plate-shaped microchip that has a substantially rectangular shape (see FIG. 2). A recessed portion that serves as a sample introduction portion 21 is provided at an upper face of the first unit 20. A liquid sample 50 is introduced into the sample introduction portion 21 (see FIG. 1A and FIG. 3A). Moreover, the width of the first unit 20 is set such that that two side edges 22 of the first unit 20 are capable of sliding along the inner walls of the second unit 30. Further, both the side edges 22 run parallel to the direction along which the first unit 20 moves from the first state illustrated in FIG. 1A to the second state illustrated in FIG. 1B. Further, the edge of the first unit 20 at an opposite side from the side at which the sample introduction portion 21 is provided configures an abutting edge 23 (see FIG. 2, FIG. 3A, and FIG. 3B). At some locations of the first unit 20, various structures necessary for carrying out measurements are also provided, such as a discharge portion 24 to which the sample 50 is discharged, a flow path 25 serving as a capillary at which an introduced sample 50 is subject to electrophoresis from the sample introduction portion 21 to the discharge portion 24, a reaction section at which a reaction of the sample 50 with a given chemical reagent occurs at a particular position along the channel, and a detection section at which a measurement light is irradiated; however, these are all omitted from the drawings.

A wide variety of specimens may be employed as the sample 50. Examples thereof include specimens of biological origin such as blood, urine, or sweat, and samples that are the subject of environmental surveys, such as those from a water survey or a geological survey. If the specimen is liquid, it may be employed as the sample 50 as is, or after being appropriately diluted or concentrated. Further, in cases in which the specimen is solid, or a highly viscous liquid or a gel, the specimen can be employed as the sample 50 only after the specimen is dissolved or dispersed in a suitable solvent so as to be in a liquid state.

The second unit 30 is formed in a substantially cuboidal box shape that has its length direction aligned with the length direction of the first unit 20. The bottom face of the second unit 30 is configured with a measurement port 34 that is a rectangular-shaped opening. An edge portion of the bottom face of the second unit 30 that surrounds the measurement port 34 configures a support edge 35 (see FIG. 2).

One of the end faces of the second unit 30 opens so as to configure an insertion port 31 (see FIG. 1A, FIG. 1B, FIG. 3A, and FIG. 3B), through which the first unit 20 is inserted into the second unit 30. Moreover, the other end face of the second unit 30 is closed so as to configure a position restriction portion 33 (see FIG. 2, FIG. 3A, and FIG. 3B). In the second state, the abutting edge 23 of the first unit 20 contacts an inner side of the position restriction portion 33 (see FIG. 3B). Further, two side faces of the second unit 30 serve as guide portions 32. The inner sides of the guide portions 32 contact the respective side edges 22 of the first unit 20 (see FIG. 2).

Explanation follows regarding functions of the present exemplary embodiment.

In the first state illustrated in FIG. 1A and FIG. 3A, the sample introduction portion 21 of the first unit 20 is positioned outside the second unit 30 relative to the open insertion port 31 of the second unit 30. In other words, at least a portion of the first unit 20 at which the sample introduction portion 21 is located is positioned so as to project out from the insertion port 31 of the second unit 30. In this state, a liquid sample 50 is introduced into the sample introduction portion 21 by being dropped thereon or directly contacted thereto.

When the first unit 20 is pressed into the second unit 30 from the first state, the first unit 20 moves into the second unit 30 as both the side edges 22 of the first unit 20 slide along the guide portions 32 of the second unit 30. Then, the second state illustrated in FIG. 1B and FIG. 3B is achieved when the abutting edge 23 of the first unit 20 abuts the position restriction portion 33 of the second unit 30. Namely, in the second state, the sample introduction portion 21 of the first unit 20 is positioned inside the second unit 30 relative to the insertion port 31 of the second unit 30.

Namely, the guide portions 32 of the second unit 30 are provided at positions along which both the side edges 22 of the first unit 20 are slidable, thus guiding the direction of movement between the first state and the second state. In other words, the guide portions 32 of the second unit 30 guide the first unit 20 from the first state to the second state. Further, the position restriction portion 33 of the second unit 30 limits further movement of the first unit 20, thereby holding the first unit 20 in the second state.

Further, throughout the movement from the first state to the second state shown above, the first unit 20 is supported in a state mounted on the support edge 35 of the bottom face of the second unit 30.

Then, in the second state, the analysis chip 10 is set in an analysis instrument (not illustrated) and predetermined measurements are performed. At this time, a predetermined operation, such as radiation of measurement light or the like, is performed through the measurement port 34 in the bottom face of the second unit 30.

The analysis chip 10 is preferably formed as a disposable unit in which all of, or almost all of, both of the first unit 20 as a microchip and the second unit 30 as a cartridge housing the first unit 30 is molded from a synthetic resin.

Moreover, in another exemplary embodiment, a structure may be provided for keeping the analysis chip 10 in the second state. For example, the first unit 20 may comprise a member to close the insertion port 31 during the second state. Further, structures that mutually engage in the second state may be provided between both the side edges 22 of the first unit 20 and the guide portions 32 of the second unit 30 (for example, recesses on both the side edges 22 and projections on the guide portions 32).

### INDUSTRIAL APPLICABILITY

The present invention may be employed for an analysis chip that includes a microchip employed for capillary electrophoresis.

What is claimed is:

1. An analysis chip employed to analyze a sample, the analysis chip comprising:
a first unit that comprises a sample introduction portion into which the sample is introduced; and
a second unit that is configured to house the first unit,
the second unit comprising an insertion port into which the first unit is inserted,
the first unit being formed so as to be moveable from a first state in which the sample introduction portion is positioned outside the second unit relative to the insertion port, to a second state in which the sample introduction portion is positioned inside the second unit relative to the insertion port, and
the second unit comprising a guide portion that guides the first unit from the first state to the second state.

2. The analysis chip of claim 1, wherein:
the first unit has two side edges running parallel to a direction of movement from the first state to the second state; and
the guide portion is provided at a position along which both the side edges are slidable in the direction of movement.

3. The analysis chip of claim 1, wherein the second unit comprises a position restriction portion that holds the first unit in the second state.

4. The analysis chip of claim 2, wherein the second unit comprises a position restriction portion that holds the first unit in the second state.

5. The analysis chip of claim 1, wherein the first unit is a microchip employed for capillary electrophoresis and the second unit is a cartridge configured to house the microchip.

6. The analysis chip of claim 5, wherein the microchip comprises a sample introduction portion into which the sample is introduced, a discharge portion to which the sample is discharged, and a flow path serving as a capillary at which the sample is subject to electrophoresis from the sample introduction portion to the discharge portion.
